(19) United States
(12) Patent Application Publication
(10) Pub. No.: US 2021/0255134 A1
(43) Pub. Date: Aug. 19, 2021

(54) BIOSENSOR AND METHOD FOR PRODUCING SAME

(71) Applicant: RUHR-UNIVERSITÄT BOCHUM, Bochum (DE)

(72) Inventors: Nicolas PLUMERÉ, Bochum (DE); Huijie ZHANG, Bochum (DE); Tobias VÖPEL, Dortmund (DE); Gabriel Bruno KOPIEC, Dortmund (DE); Darren BUESEN, Bochum (DE)

(21) Appl. No.: 16/973,828

(22) PCT Filed: Jun. 12, 2019
(86) PCT No.: PCT/EP2019/065346

§ 371 Date: Dec. 10, 2020

(30) Foreign Application Priority Data
Jun. 14, 2018 (DE) 10 2018 114 206.4

(51) Int. Cl. G01N 27/327

(52) U.S. Cl. CPC G01N 27/3272; G01N 27/3274

(57) ABSTRACT

Provided is an electrochemical biosensor for the detection of at least one analyte dissolved in an analyte solvent, including a capillary detection space and a plurality of electrodes, wherein the plurality of electrodes includes at least one working electrode having a measuring region positioned in the capillary detection space, which is provided with an immobile detection agent for interacting with the analyte, and wherein the plurality of electrodes further includes a counter electrode extending into the capillary detection space, and wherein the plurality of electrodes is electrically contactable outside the capillary detection space, wherein the capillary detection space has a volume in a range of ≤10 μl, wherein an oxygen-binding or oxygen-reactive inerting agent is further provided in the capillary detection space, which is positioned at least partially between the working electrode and an inlet opening of the capillary detection space.

### CROSS-REFERENCE TO RELATED APPLICATIONS

This application claims priority to PCT Application No. PCT/EP2019/065346, having a filing date of Jun. 12, 2019, based on German Application No. 10 2018 114 206.4, having a filing date of Jun. 14, 2018, the entire contents both of which are hereby incorporated by reference.

### FIELD OF TECHNOLOGY

The following relates to a biosensor. The following also relates to a biosensor with improved resistance to the influence of oxygen. The following further relates to a method for making such a sensor and a system comprising such a sensor. Furthermore, the following relates to a method for detecting an analyte.

### BACKGROUND

Electrochemical biosensors are generally widely known. Currently, electrochemical biosensors are mainly used, for example, to determine the glucose concentration or the lactose concentration of an aqueous sample by an enzymatic reaction.

The most common electrochemical biosensors are used to determine the glucose content of various samples. They are of great importance in areas such as food analysis or medical diagnostics. Every day in Germany, several million blood glucose measurements (approx. 24 million measurements per day) are performed on diabetes mellitus patients. This practice has led to an improved treatment of diabetes and the daily treatment plan cannot be imagined without it. However, the accuracy of commercially available devices is controversially discussed, as it can lead to undesirable mistreatment/estimates, which in some cases have already led to the death of patients (Olansky, Diabetes Care, 2010). According to DIN EN ISO 15197:2015, the following rules for the accuracy of blood glucose meters have recently become effective: The measured values may not deviate from the laboratory value by more than ±15% for measured values ≥100 mg/dl and ±15 mg/dl for measured values below 100 mg/dl. Individual treatment success can be improved by reducing the tolerances. The most widely used biosensors for glucose on the market are based on the enzymes glucose dehydrogenase (GDH) or glucose oxidase (GO). Both enzymes have different disadvantages which can influence the accuracy of the measurement. For example, some of the GDH-based systems (test strips with GDH-PQQ) provide false values in the presence of certain drugs and react unspecifically with other sugars such as maltose, galactose, and xylose. Otherwise, falsely increased values can occur, which can lead to non-recognition of hypoglycemia with fatal consequences. For this reason, the FDA issued a warning in 2009 advising against the use of GDH-PQQ systems when treating patients with drugs containing these sugars (FDA Public Health Notification: Potentially Fatal Errors with GDH-PQQ* Glucose Monitoring Technology). Mutated variants of the enzyme are now also used, which have a reduced affinity for sugars other than glucose.

However, there are also reports that mutated forms of the enzyme have resulted in increased values in the presence of galactose (Ceriotti, J. Clin. Sci. Tech., 2015). Other GDH based test systems are also used where the specificity of the enzyme for other sugars does not lead to falsified results (GDH-FAD, GDH-NAD). GO-based test systems are less susceptible to drugs, pH and temperature in patient blood and are not susceptible to other sugars due to their specificity for glucose. Furthermore, GO is inexpensive to produce and very sensitive (Aggidis, Biosensors and Bioelectronics, 2015).

However, GO test systems show a sensitivity to increased or decreased oxygen concentrations, the so-called oxygen effect. An increased oxygen concentration leads to lower measured values, whereas a decreased oxygen concentration results in excessive measured values (Schmid, Diabetes Technol Ther., 2014). In the presence of oxygen, hydrogen peroxide is also formed, which can deactivate the GO used (Prévoteau, Electrochimica Acta, 2012).

According to the current state of the art, biosensors are known in which the influence of oxygen, the so-called oxygen effect, is to be eliminated by correction methods. The disadvantage of this correction method is the necessity of an additional electrode, which makes the construction of a sensor more complex and therefore more cost-intensive. Furthermore, a consideration of the oxygen effect is known by the simultaneous use of GO and GDH. But the disadvantage of this method is also here that an additional electrode is necessary, which makes the construction of the sensor more complex and cost-intensive. Furthermore, in the described methods the oxygen is not removed, but only its influence is measured and subsequently corrected. These systems only work for the determination of glucose because they use the properties of the glucose-specific sensor enzymes.

According to the current state of the art, methods are also known that remove oxygen or other molecules in a biosensor.

For example, biosensors are known from Maidan R, Heller A. Elimination of electrooxidizable interferants in glucose electrodes, JACS, 1991, 113 (23), 9003-9004 or also Lopez F, Ma S, Ludwig R, Schuhmann W, Ruff A. A Polymer Multilayer Based Amperometric Biosensor for the Detection of Lactose in the Presence of High Concentrations of Glucose, Electroanalysis, 2017, 29 (1), 154-161. The biosensors described here consist of several layers. The lowest layer is electrically connected to the electrode and can transfer electrons. In this layer is an enzyme which is specific for the analyte. On top of this layer a further layer is applied in which enzymes for the removal of oxygen (Maidan, JACS, 1991) or other molecules such as glucose (Lopez, Electroanalysis, 2017) and hydrogen peroxide are embedded. On a laboratory scale, this procedure is suitable for producing interference-resistant biosensors. However, the production of a multilayer for mass production (approx. 750 million test strips per day (worldwide), 24 million test strips per day (Germany)) is less suitable, as it is more cost-intensive.

Lopez F, Ma S, Ludwig R, Schuhmann W, Ruff A. A Polymer Multilayer Based Amperometric Biosensor for the Detection of Lactose in the Presence of High Concentrations of Glucose, Electroanalysis, 2017, 29 (1), 154-161 also describes a method for oxygen removal using a specific enzyme system described in Plumeré et al. Chem., 2012 (see above). This enzyme system is used here as part of a multilayer. This means that a sensor enzyme is covered by a polymer layer in which the enzymes for oxygen removal are embedded. However, this method has the disadvantage that on the one hand the production of such a test strip or biosensor is comparatively complex and therefore cost-intensive and on the other hand the performance of the biosensor may not be optimal.

Maidan R, Heller A. Elimination of electrooxidizable interferants in glucose electrodes, JACS, 1991, 113 (23), 9003-9004 further describes that in order to generate hydrogen peroxide, oxygen is removed by an enzyme system (lactate oxidase) as a side reaction. Comparatively large sample volumes are used.

In Monteiro T, Rodrigues P R, Gonçalves A L, Moura J J, Jubete E, Añorga L, Piknova B, Schechter A N, Silveira C M, Almeida M G. Construction of effective disposable biosensors for point of care testing of nitrites, Talanta. 2015 Sep. 1; 142:246-51, also the enzyme system for oxygen removal is used, which was described in the above-mentioned publication Plumeré et al. Chem. 2012 described above. The sample volume used here is according to the experiment at sample volumes ≥100 μl.

In the method described in Quan D, Shim J H, Kim J D, Park H S, Cha G S, Nam H, Electrochemical determination of nitrate with nitrate reductase-immobilized electrodes under ambient air, Anal. Chem., 2005, 77(14):4467-4473, oxygen is removed with the aid of sulfite. The described screen-printed electrode is integrated into a sample vessel. The volume of this vessel is designed for a volume of ≥100 μl.

However, such solutions known from the state of the art can still show potential for improvement, especially regarding an effective and reliable measurement with biosensors at very small sample volumes.

### SUMMARY

An aspect relates to a solution that enables an effective and safe measurement with biosensors at very small sample volumes.

The embodiments of the present invention relate to an electrochemical biosensor for the detection of at least one analyte dissolved in an analyte solvent, comprising a capillary detection space and a plurality of electrodes, wherein the plurality of electrodes comprises at least one working electrode having a measuring region positioned in the capillary detection space, which is provided with an immobile detection agent for interacting with the analyte, and wherein the plurality of electrodes further comprises a counter electrode extending into the capillary detection space, and wherein the plurality of electrodes is electrically contactable outside the capillary detection space, wherein the capillary detection space has a volume in a range of ≤10 μl, wherein an oxygen-binding or oxygen-reactive inerting agent is further provided in the capillary detection space, which is positioned at least partially between the working electrode and an inlet opening of the capillary detection space, and wherein the length of the capillary detection space between the working electrode and the inlet opening and the inerting agent are selected and adapted to one another in such a way, in that oxygen diffusing in the analyte solvent arranged in the detection space from the inlet opening in the direction of the working electrode can be completely removed from the analyte solvent by the inerting agent before reaching the working electrode.

Such a biosensor can easily allow a reliable and especially oxygen independent detection of an analyte to be detected, whereby the analyte is dissolved in an analyte solvent. Thereby, only a qualitative or only a quantitative detection or both a qualitative and a quantitative detection can be performed.

To make this possible, it is planned that the biosensor will initially have a capillary detection space. A capillary detection space is to be understood as such a space or volume in which the detection of the analyte takes place, and which is designed as a capillary. A capillary detection space is a space or volume in which the detection of the analyte takes place, and which is designed as a capillary. The biosensor described here has a small volume in a range of ≤10 μ1, for example ≤5 μl.

Further, the biosensor comprises a plurality of electrodes, the plurality of electrodes comprising at least one working electrode having a measuring region positioned in the capillary detection space provided with an immobile detection agent for interacting with the analyte. In other words, the working electrode known per se for electrochemical biosensors is provided with a detection agent which is not mobile, i.e. which also remains in contact with the analyte or the analyte solvent at the desired position. A detection agent is supposed to be such an agent, such as a reagent, which interacts with the analyte, for example reacts, in a known manner so that the reaction with the analyte and thus the analyte itself can be detected using the working electrode.

Accordingly, the majority of electrodes also have a counter-electrode that extends into the capillary detection space and thus also comes into contact with the analyte solvent.

Furthermore, a so-called reference electrode can be provided, for example, whereby a so-called three-electrode arrangement can be created. Such an arrangement can be chosen to be as uninfluenced as possible by current-dependent processes at the counter electrode in an exemplary amperometric measurement. This three-electrode arrangement thus comprises a working, a counter, and a reference electrode. The reaction or interaction of analytical interest takes place at the working electrode, whereby the potential is controlled with a high-impedance reference electrode. The low-resistance counter-electrode serves only as a current contact. All deviations from the preselected nominal value of the working voltage can thus be automatically corrected by a potentiostat.

Accordingly, if the working electrode and the counter electrode and, if necessary, other electrodes present outside the capillary detection space can be electrically contacted, an electrochemical detection of the analyte can take place by amperometric measurements. For this purpose, the current flow can thus be measured via an at best very sensitive amperemeter, whereby the level of the current is proportional to the concentration of the analyte. Such a functionality is basically known for electrochemical biosensors. For the determination of the analyte, however, different electrochemical methods such as coulometry, amperometry, voltammetry, or potentiometry can be used in principle.

In the case of the biosensor described here, it is further provided that an oxygen-binding or oxygen-reactive inerting agent is provided in the capillary detection space, which is positioned at least partially between the working electrode and an inlet opening of the capillary detection space. Such an inerting agent can be used to remove oxygen present in the analyte solvent from the latter. For this purpose, the oxygen can be bound to the inerting agent or react with the inerting agent. Furthermore, an inlet opening is such an opening of the detection space, through which the analyte solution to be investigated enters the detection space.

It is further provided that the length of the capillary detection space between the working electrode and the inlet opening and the inerting agent are selected and adapted to each other in such a way that oxygen diffusing from the inlet opening in the direction towards the working electrode in the analyte solvent is completely removable by the interting agent from the analyte solvent before reaching the detection agent.

In other words, it is intended that not only a freely selectable inerting agent in a freely selectable quantity is positioned in a detection space with a freely selectable size, but that a large number of parameters are specifically adapted to each other in such a way as to ensure that no oxygen can reach the working electrode and the detection agent by diffusion processes from the inlet opening. The parameters that can be adapted to each other include the length of the capillary detection space between the working electrode and the inlet opening and the inerting agent. Adaptation of the inerting agent can be understood as the type and quantity of the inerting agent.

In order to optimize the oxygen removal and the distance of the electrode to the inlet opening or capillary opening, such an adjustment of the respective parameters can be carried out experimentally, for example by tests. Furthermore, this can be done by a computer simulation, which provides information about the exact dimensions and the concentrations of the inerting agent, such as an enzyme, to be used. This allows an optimized and therefore cost-effective design of a biosensor and thus an improved manufacturability.

With regard to the oxygen concentration in the analyte solvent, this can be included in the consideration, even if the influence is rather small. Under normal environmental conditions the oxygen concentration should fluctuate. One can assume about 8 mg/l, which corresponds approximately to a concentration at 25° C. The working range of a sensor is usually in a temperature range from 10° C. to 37° C. In this range, the dissolved oxygen concentration is approximately in the range of 11.3 to 6.7 mg/1 at normal pressure (1013 hPa). These values barely change the operation of the inerting agent.

The embodiment described above may have significant advantages over state-of-the-art solutions.

The biosensor described above can especially meet the problem that electrochemical biosensors are influenced by dissolved oxygen and furthermore by additional solution processes from the ambient air. In detail, in electrochemical biosensors the presence of dissolved oxygen leads to a short circuit of the electron transfer process from the analyte to the electrode. This leads to considerable inaccuracies at low analyte concentrations. With small volumes of the detection space or the analyte solvent, the detection agent can therefore be protected from the influence of oxygen.

For large volumes, the diffusion of oxygen to the electrode is limited by the large distances from the solution surface to the electrode, so oxygen can be removed relatively easily before interference can occur. In small volumes, however, it has been found that the distance from the inlet opening to the working electrode or to the detection agent is so small that diffusion processes become significant. Therefore, the biosensor described here is especially relevant and advantageous for small sample volumes. For an effective measurement and the effective presence of the advantages described above, it can be advantageous if the volume of the capillary detection space is in a range from ≤10 μl, about ≤5 μl, for example in a range from ≥0.5 μl to ≤10 μl, such as from ≥1 μl to ≤5 μl, for example in a range from ≥1.5 μl to ≤3 μl, or in a range from ≥0.3 μl to ≤0.5 μl.

Thus, embodiments of the present invention is of high relevance especially for biosensors, since biosensors are characterized on the one hand by a very specific detection of the analyte and on the other hand by a high sensitivity and a very low detection limit for the analyte and thus biosensors are suitable for small volumes.

Thus, a biosensor is proposed that can be used in a safe and effective way to remove dissolved oxygen in a system for the determination of an analyte with low analyte volume. It has been found that the design and construction of the biosensor, for example as a test strip, allows a corresponding method, whereby the influence of oxygen can be significantly reduced or even completely excluded.

In summary, the dimensions of the test strip and the biosensor described here are such that the oxygen can be completely removed by the interting agent before the oxygen reaches the working electrode or the detection agent by diffusion processes. This prevents oxygen from negatively influencing the analysis or the methodology of the biosensor.

In accordance with the above, a safe and reliable measurement or detection can thus be achieved, whereby an oxygen-containing environment can have no or only a negligible influence on the measurement result.

Thereby, corresponding biosensors can be produced easily and cost-effectively, since the manufacturing principle can be easily adapted from known biosensors by selecting the appropriate parameters as described above.

With regard to applicability, improved biosensors can be produced in a non-restrictive manner for glucose determination in blood and other aqueous solutions. In addition, biosensors for new fields of application, such as nitrate determination, can be produced without being limited to the above examples.

The distance between the working electrode and the inlet opening, i.e. the nearest inlet opening when several inlet openings are provided, may be in the range from ≥2 mm to ≤15 mm, or in the range from ≥3 mm to ≤8 mm. It turned out that especially in this configuration the inerting agent, and especially the amount and the type or the activity of oxygen binding or the oxygen reaction, can be formed in an advantageous way. In other words, it can be especially ensured that the oxygen cannot reach the working electrode by diffusion processes. This is especially true for the previously described volumes of the capillary detection space in a range from ≥0.5 μl to ≤10 μl.

From the above it is further evident that especially in this configuration a high effectiveness of oxygen removal can be possible. Because even if oxygen begins to diffuse through the analyte solvent, an interaction with the analyte solvent can take place at any position. Thus, the oxygen can be removed particularly effectively or a comparatively small amount of inerting agent is sufficient to remove the oxygen. This allows, for example, a sensor of conventional size with little inerting agent or a sensor with a compact design, both of which can be advantageous for specific applications.

Furthermore, it can be an advantage that the inerting agent is an enzyme-based inerting agent. Especially such inerting agents can be characterized by an effective removal of oxygen from the analyte solvent and thus reduce the influence of an oxygen environment for the biosensor. In addition, such systems can leave the actual measurement untouched in the respective applications, so that such inerting agents combine effective oxygen removal with a reliable measurement result.

An example of such enzyme systems that can be used as inerting agents includes, but is not limited to, pyranose 2-oxidase (P2Ox) with a catalase (Pox CAT).

The detection agent may be an enzyme-based detection agent. The selection of the detection agent is basically and also in this application in a way that is obvious to the expert dependent on the desired application. For the exemplary case of a glucose sensor, an enzyme-based detection agent may have glucose dehydrogenase (GDH) or glucose oxidase (Gox) as an example, but this is not limited to this.

The sensor enzymes can, for example, be both reductases and oxidases, regardless of whether the sensor enzyme is used as an inerting agent or as a detection agent.

Embodiments of the present invention thus relate in summary to an electrochemical biosensor designed as a test strip for various analytes, whereby the detection agent used, such as sensor enzymes, can also be sensitive to oxygen or interfere with oxygen even in the potential range of the analyte. The oxygen dissolved in the sample is effectively removed so that an analyte can be determined in an aqueous solution such as whole blood, plant juice, beverages, or other solutions without the need to protect the sample from atmospheric oxygen. This allows significant advantages in the applicability and the possible field of application.

With regard to further advantages and technical features of the biosensor, reference is hereby made to the description of the system, the method of making a biosensor, the method of detecting an analyte and its use, as well as to the figures and the description of the figures, and vice versa.

A system is further described for the qualitative or quantitative detection of at least one analyte dissolved in an analyte solvent, comprising a biosensor as described in detail above, and further comprising an analyte solvent arranged in the capillary detection space, wherein at least one analyte to be detected is provided in the analyte solvent.

The system described here therefore initially features a biosensor, whereby reference is made to the above explanations regarding the biosensor. It is further intended that an analyte solvent is provided in the capillary detection space, whereby at least one analyte to be detected is provided in the analyte solvent.

With such a system it is possible to detect the analyte reliably without oxygen diffusing through the analyte solvent negatively influencing a detection, for example an amperometric measurement, or falsifying the measurement. The analyte solvent or the analyte can be selected in a way that is understandable for the expert with regard to the specific area of application. The same applies to the detection solvent, as described in detail above.

It may be that the inerting agent is at least partially soluble or dissolved in the analyte solvent. It may be that the inerting agent is completely soluble or dissolved in the analyte solvent. In this configuration, a safe and effective removal of oxygen present in the analyte solvent can be enabled.

On the one hand, it can be ensured that oxygen diffusing through the analyte solvent comes into contact with the inerting agent, so that an interaction between oxygen and inerting agent can be ensured.

On the other hand, the biosensor can be manufactured very easily in this design. This is due to the fact that the inerting agent can easily be placed or positioned at any position of the detection space, especially between the working electrode and the outlet, without having to achieve a highly exact positioning over a defined area. Because the inerting agent is then dissolved in the analyte solvent, the inerting agent is distributed solely by dissolution processes and thus by corresponding mixing processes, so that the inerting agent is present in the entire detection space.

Thus, especially in this embodiment, an effective oxygen removal can be easily achieved.

It may also be that the system further comprises an evaluation unit which electrically contacts the plurality of electrodes and by which at least one of the amount and the type of the analyte can be determined from information supplied by the electrodes. Such an evaluation unit can thus electrically contact the electrodes. For this purpose, it may be provided that the sensor can be inserted into a receiving area of the evaluation unit so that the electrodes are contacted at a defined position of the biosensor in the evaluation unit and the quantity and/or type of the analyte can be determined or, in other words, the generation of a measurement result is permitted. The information provided by the electrodes can be understood as, for example, a current or a voltage, which can be detected by appropriate measuring methods.

If, for example, the evaluation unit is designed for an amperometric measurement or for carrying out other measurement methods as described above, an evaluation can be carried out simply by inserting the biosensor, which is designed as a test strip, into the evaluation unit, so that the presence of the analyte can be indicated quantitatively and/or qualitatively.

With regard to further advantages and technical features of the system, reference is hereby made to the description of the biosensor, the method for making a biosensor, the method for detecting an analyte and its use, as well as to the figures and the description of the figures, and vice versa.

A method for the detection of at least one analyte dissolved in a solvent is also described, comprising the method steps:
a) providing a biosensor as described in detail above,
b) filling the capillary detection space with analyte dissolved in the analyte solvent, wherein
c) when filling the capillary detection space, the analyte solvent is passed together with the analyte from the inlet opening to the detection agent;
d) contacting the at least two electrodes externally; and
e) determining at least one of the amounts and the type of the analyte by information provided by the electrodes.

The method described here therefore serves to detect at least one analyte dissolved in a solvent. The detection can comprise a qualitative detection, a quantitative detection or a qualitative and a quantitative detection.

To make this possible, the method includes the following steps.

First, a biosensor is provided according to step a), as described in detail above. Thus, with regard to the respective features of the biosensor, reference is made to the above explanations.

The capillary detection space is now filled with analytes dissolved in the analyte solvent according to method step b). In other words, the analyte solvent is introduced or filled into the detection space together with the analyte dissolved in it. This can be done, for example, purely by the capillary forces of the capillary detection space, in which the biosensor with an inlet opening of the detection space is immersed in the analyte solvent and thus in the solution to be investigated and the solvent thus enters the capillary detection space and approximately completely fills it.

Method step b) should be performed in such a way that the analyte dissolved in the analyte solvent is present at the detection agent and the counter electrode in order to be able to perform a corresponding detection. This is generally unproblematic as long as the detection space is completely filled with analyte solvent as described above.

According to method step c) it is further provided that when filling the capillary detection space, the analyte solvent is led together with the analyte from the inlet opening to the detection agent.

It can be provided that the analyte solvent is guided along the inerting agent or flows along it and thus contacts the inerting agent when filling the detection space.

On the one hand, this can help to remove oxygen from the analyte solvent, for example by a reaction, or to immobilize it. In addition, this can be advantageous if the inerting agent is soluble in the analyte solvent, so that the inerting agent can be dissolved at least partially, completely, and/or immediately when the analyte solvent flows in. The latter allows an effective reduction of the influence of oxygen and furthermore an improved producibility of the biosensor.

Finally, according to steps d) and e), external contacting of the at least two electrodes is carried out; and determining at least one of the amount and type of the analyte by information provided by the electrodes and thereby a qualitative and/or quantitative determination of the analyte. In these steps an evaluation is thus made possible, for example, by contacting the electrodes, i.e. at least the working electrode and the counter electrode. This can be done by fundamentally different electrochemical methods such as coulometry, amperometry, voltammetry, or potentiometry, so that the information of the electrodes is electrical or electrochemical information, such as current intensity, voltage, etc.

Furthermore, this method step may be possible by inserting the biosensor into an evaluation unit, as described in more detail above.

The method described here thus allows an effective and reliable quantitative and/or qualitative detection of the analyte dissolved in the analyte solvent. An influence by oxygen diffusing to the detection agent can be prevented.

Following the above, it may be that oxygen diffusing from the inlet opening in the direction of the detection agent in the analyte solvent is completely removed from the analyte solvent by the inerting agent.

Especially in this configuration an effective detection can be achieved, which is independent from the biosensor surrounding oxygen.

With regard to further advantages and technical features of the method for detecting an analyte, reference is hereby made to the description of the system, the biosensor, the method for making a biosensor, and its use, as well as to the figures and the description of the figures, and vice versa.

It also describes a method for making a biosensor for the detection of at least one analyte dissolved in an analyte solvent, a biosensor as described in detail above, wherein the method comprises the method steps
i) providing a base body with a capillary detection space, wherein the detection space has a volume in a range of ≤10 μl
ii) arranging a plurality of electrodes in such a way that they are externally electrically contactable and extend into the detection space;
iii) arranging a detection agent on an electrode serving as a working electrode; and
iv) arranging an inerting agent in the detection space, between an inlet opening of the detection space and the electrode serving as a working electrode, wherein
v) the length of the capillary detection space between the electrode serving as working electrode and the inlet opening and the inerting agent are selected and adapted to each other in such a way, in that oxygen diffusing in the analyte solvent from the inlet opening in the direction of the electrode serving as working electrode can be completely removed from the analyte solvent by the inerting agent before reaching the detection agent.

It may be provided that the method steps described above are carried out in the order described above or in an order different from the order described above. In addition, the respective method steps can each be single steps or have a plurality of substeps, wherein the substeps of different method steps can overlap in time or wherein one or more substeps of a method step can at least partially run between substeps of a further method step without leaving the scope of embodiments of the invention.

Furthermore, with regard to the individual features, reference is made to the description and the corresponding properties and embodiments, as they are described elsewhere, for example in the description of the biosensor.

The method for making the biosensor has the following steps.

First of all, according to method step i), a base body with a capillary detection space is provided, whereby the detection space has a volume in a range of ≤10 μl, approximately ≤5 μl. In this method step, the basic structure of the biosensor is designed, which can support the functional parts described below.

Basically, the base body can be formed from one part or can be built up from a number of individual parts. For example, it may be intended that the following method steps are used to form the base body:
vi) providing a sensor cover;
vii) applying two lateral boundaries to the sensor cover in such a way that the lateral boundaries define an interspace between the lateral boundaries forming the detection space, and that the lateral boundaries form an inlet opening on at least one side;
ix) providing a sensor base; and
xii) fixing the sensor base on the lateral boundaries.

It should be ensured that previously applied electrodes or a previously applied detection agent is present in the detection space. This can be easily achieved by dimensioning the individual parts accordingly or by positioning the electrodes and the detection agent accordingly.

Furthermore, the base body, such as comprising the sensor cover, the sensor base, and the lateral boundaries, can be formed from paper, cardboard, plastic, or other materials. Furthermore, the sensor cover and the sensor base as well as the lateral boundaries can be shaped like a plate. The capillary detection space can be formed easily by gluing the sensor base, the lateral boundaries and the sensor cover together.

Furthermore, in the method described here, according to method step ii), a plurality of electrodes are arranged in such a way that they can be contacted electrically externally and extend into the detection space. Thus, the electrodes have a region which is arranged in such a way that it is positioned in the detection space in the case of a generated sensor, and further have a region which can be contacted externally.

Only one working electrode and one counter electrode can be applied, or an additional reference electrode can be applied as described above. Furthermore, the application of the electrodes can be made possible by a printing method, for example by a screen printing method, a structured electrically conductive layer, for example a layer of carbon or a metal, such as gold.

For example, the electrodes can be applied to the sensor cover according to method step x) before it is fixed to the side parts or the lateral boundaries.

In addition, in the method described here, in accordance with the method steps iii) and xi), a detection agent is arranged on an electrode serving as a working electrode. This step can take place, for example, after the electrode has been applied as described above and/or before the sensor base is joined to the lateral boundaries in the described embodiment.

In addition to the application of the detection agent as described above, the method further comprises in accordance with method step iv) the arrangement of an inerting agent in the detection space, between an inlet opening of the detection space and the detection agent. In this respect the inerting agent can be selected as described in detail above and the inerting agent can basically be applied by a selectable method. For example, it can be applied by a conventional coating method.

For example, it may be intended that the inerting agent is applied in the above-described embodiment of the production of the base body according to method step viii) after the lateral boundaries have been applied to the sensor cover and before the sensor base is fixed to the lateral boundaries and thus applied into the interspace. Then the inerting agent can also be applied to the sensor cover.

Following the above, it may therefore be intended that the method for making the biosensor includes the following method steps:
vi) providing a sensor cover;
vii) applying two lateral boundaries to the sensor cover in such a way that the lateral boundaries define an interspace between the lateral boundaries forming the detection space, and that the lateral boundaries form an inlet opening on at least one side;
(viii) applying an inerting agent to the interspace;
ix) providing of a sensor base;
x) applying at least two electrodes to the sensor base;
(xi) applying a detection agent to an electrode to be used as a working electrode; and
xii) fixing the sensor base on the lateral boundaries in such a way that the electrodes extend into the detection space formed by the interspace, and that the detection agent is present in the detection space.

In principle it is further provided according to method step v) that the length of the capillary detection space between the electrode serving as working electrode and the inlet opening and the inerting agent are selected and adapted to each other in such a way that oxygen diffusing in the analyte solvent from the inlet opening in the direction of the electrode serving as working electrode can be completely removed from the analyte solvent before reaching the electrode serving as working electrode by the inerting agent.

This feature allows, as described in more detail above with reference to the sensor, that oxygen diffusing through an analyte solvent present in the detection space does not reach the electrode serving as working electrode. This allows a safe and effective measurement which is also very independent of the presence of oxygen outside the sensor.

With regard to further advantages and technical features of the method for making a biosensor, reference is made to the description of the system, the biosensor, the method for detecting an analyte, and its use, as well as to the figures and the description of the figures, and vice versa.

Further described is the use of at least one of a sensor, system or method, i.e. a method for preparing a biosensor or a method for detecting at least one analyte dissolved in an analyte solvent, as described in detail above, for the detection of at least one analyte dissolved in a solvent. The detection can be qualitative, quantitative, or qualitative and quantitative.

This use enables a safe and effective detection of the analyte, which is also very independent of the presence of oxygen outside the sensor.

For example, the use of at least one of a sensor, system, or method, as described in detail above, is made for glucose or nitrate determination.

With regard to further advantages and technical features of the use, reference is hereby made to the description of the system, the biosensor, the method for detecting an analyte, and the method for making a biosensor, as well as to the figures and the description of the figures, and vice versa.

### BRIEF DESCRIPTION

Some of the embodiments will be described in detail, with reference to the following figures, wherein like designations denote like members, wherein:

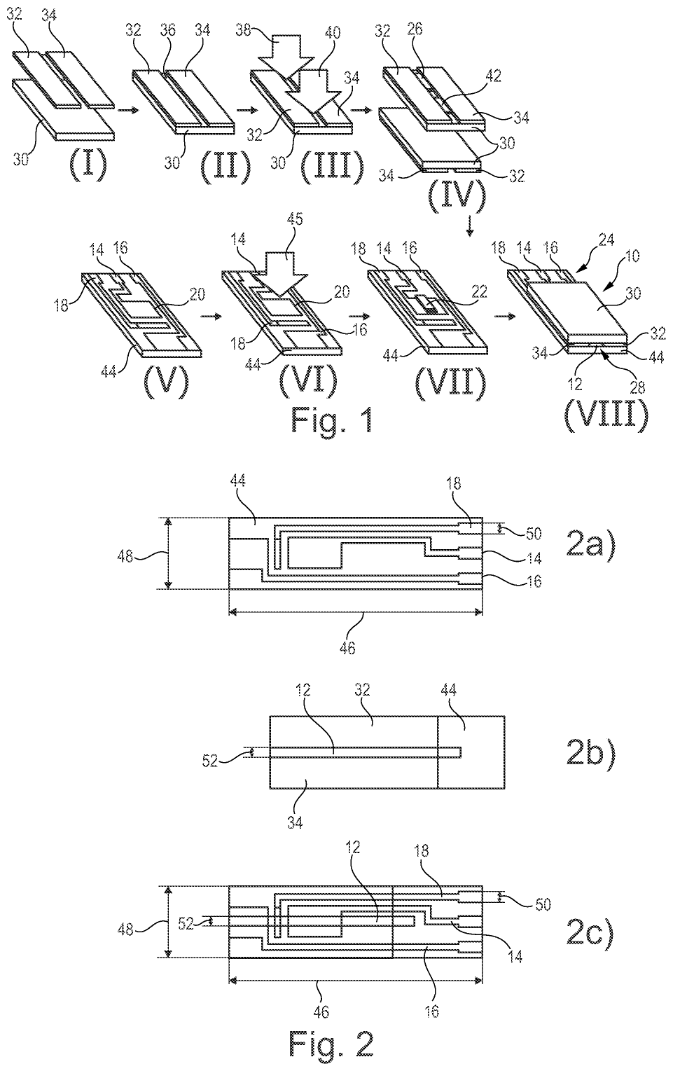

FIG. 1 a schematic view of a biosensor and a method for making the same;

FIG. 2a a schematic partially transparent view in different shapes to visualize the dimensions of the biosensor;

FIG. 2b shows a transparent top view of a part of step VIII;

FIG. 2c shows a partly transparent view of step VIII for clarification;

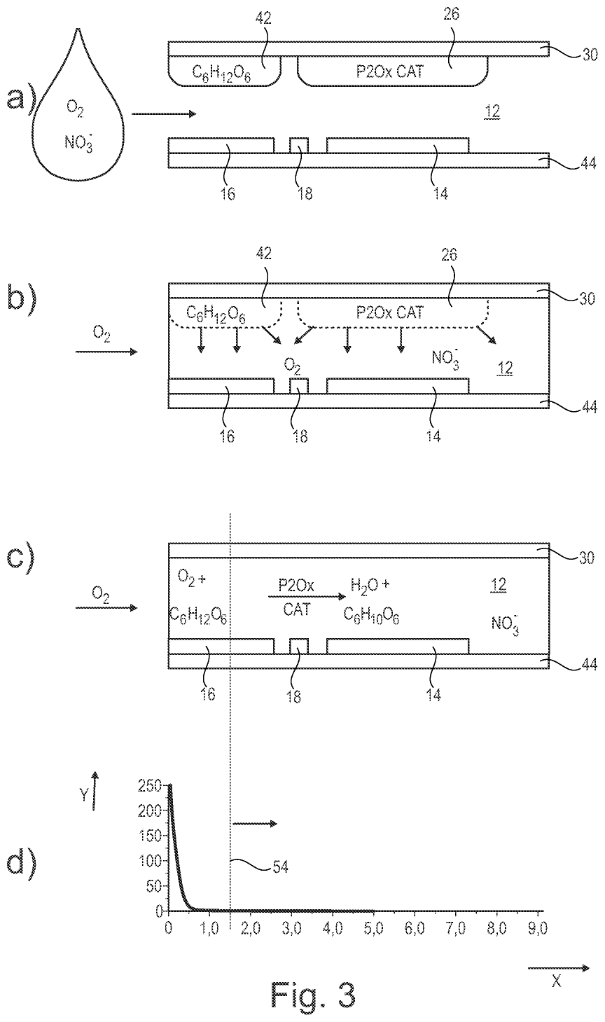

FIG. 3a different cross sections through the detection space of the biosensor for describing the oxygen removal by an enzyme system;

FIG. 3b shows a configuration where an inerting agent, can start to remove the dissolved oxygen by reacting the glucose as reagent with the oxygen;

FIG. 3c an interference-free measurement of the analyte can be performed as shown;

FIG. 3d shows the oxygen content in the analyte solvent in μM on the Y-axis relative to the distance to the inlet opening, which is shown in mm on the X-axis;

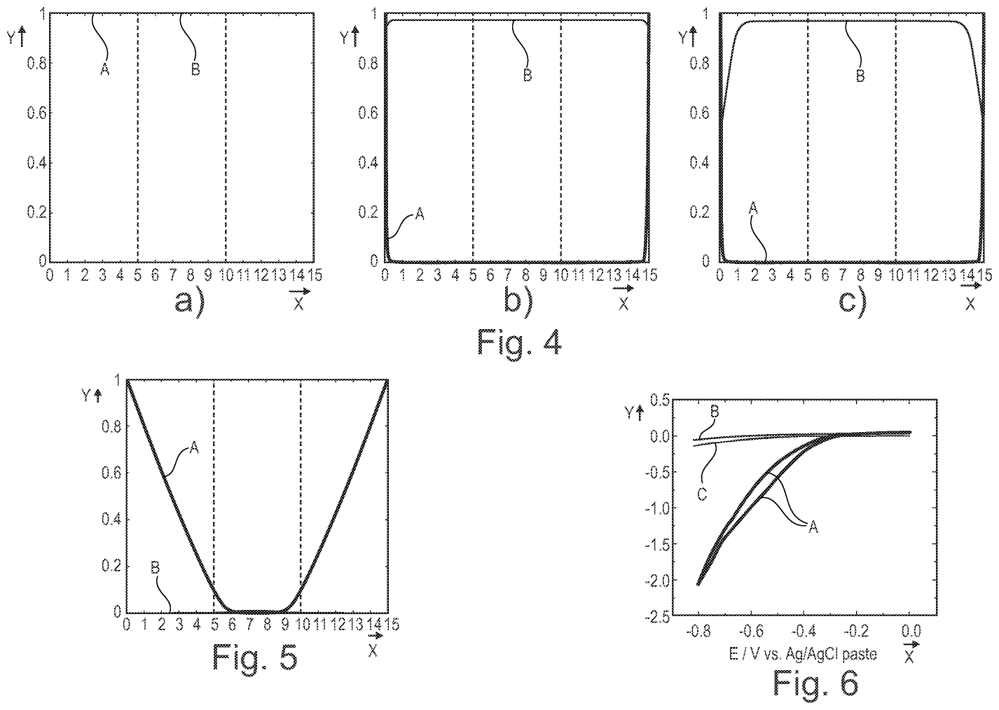

FIG. 4a is a diagram showing a simulation of oxygen removal by an enzyme system;

FIG. 4b is a diagram showing a simulation of oxygen removal by an enzyme system;

FIG. 4c is a diagram showing a simulation of oxygen removal by an enzyme system;

FIG. 5 another diagram showing a simulation of oxygen removal by an enzyme system

FIG. 6 a diagram showing the behaviour of a biosensor without an inerting agent;

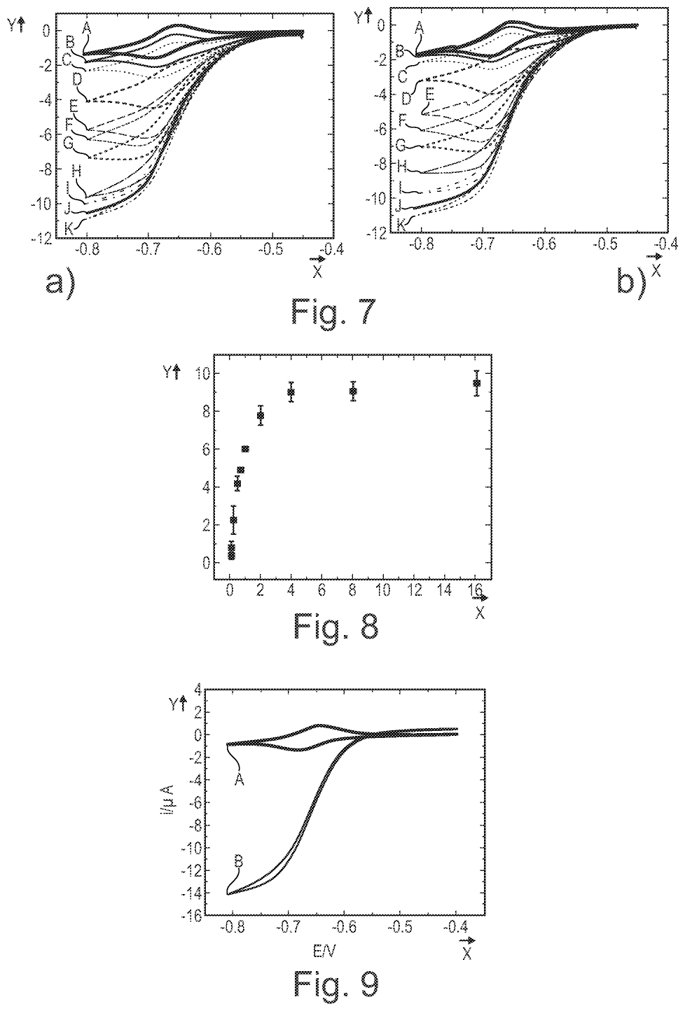

FIG. 7a is a diagram showing the measuring behavior of a biosensor at different analyte concentrations;

FIG. 7b is a diagram showing the measuring behavior of a biosensor at different analyte concentrations;

FIG. 8 another diagram showing the measuring behavior of a biosensor at different analyte concentrations; and

FIG. 9 another diagram showing the measuring behavior of a biosensor.

### DETAILED DESCRIPTION

In FIG. 1 a biosensor 10 and a method for making the same is described.

An electrochemical biosensor 10 is generated for the detection of at least one analyte dissolved in an analyte solvent. Such a biosensor 10 comprises a capillary detection space 12 which has a volume in a range from ≤10 μl, for example ≤5 μl, or in a range from ≥1.5 μl to ≤3 μl. Furthermore, the biosensor 10 comprises a plurality of electrodes, namely a working electrode 14, a counter electrode 16 and a reference electrode 18. The working electrode 14 has a measuring region 20 positioned in the capillary detection space 12, which is provided with an immobile detection agent 22 for interaction with the analyte. Furthermore, all electrodes 14, 16, 18 extend into the detection space 12 and can be electrically contacted from outside. For this purpose, the biosensor has a contact area 24 in which the electrodes 14, 16, 18 are exposed. For example, the contact area 24 can be pushed into an evaluation unit to enable an evaluation of the detection or measurement.

It is further provided that an oxygen-binding or oxygen-reactive inerting agent 26 is further provided in the capillary detection space 12, which is positioned at least partially between the immobile detection agent 22 or the working electrode 14 and an inlet opening 28 of the capillary detection space 12.

For effective and oxygen-independent detection, it is further provided that the length of the capillary detection space 12 between the working electrode 14 and the inlet opening 28 and the inerting agent 26 are selected and adapted to one another in such a way that oxygen diffusing from the inlet opening 28 in the direction of the working electrode 14 in an analyte solvent present in the detection space 12 can be completely removed from the analyte solvent before reaching the working electrode 14 by the inerting agent 26. For example, as shown below, the distance between the working electrode 14 and the inlet opening 28 may be provided in a range ≥2 mm to ≤15 mm.

Such a sensor is shown in FIG. 1 as the final product of the method shown there as stage VIII. Such an embodiment can be described as a test strip, which is flat, especially in comparison to the width, and is constructed in several layers.

The method for making such a biosensor 10 can be approximately as follows, as shown in FIG. 1. Basically, according to FIG. 1, a first part is produced as stage IV and a second part as stage VII, which are then connected to each other as stage VIII to form the biosensor 10.

To produce stage IV, a sensor cover 30 and two lateral boundaries 32, 34 are first provided as stage I. Then, to produce stage II, the lateral boundaries 32, 34 are applied to the sensor cover 30 and fixed there, e.g. by gluing, in such a way that the lateral boundaries 32, 34 define an interspace 36 between the lateral boundaries 32, 34 forming the detection space 12, the lateral boundaries 32, 34 forming the inlet opening 28 on at least one side.

Subsequently, the inerting agent 26 is applied to the interspace 36 to create stage IV. Depending on the application possibilities, e.g. of a coating, inerting agent 26 can be applied as intermediate stage III while still moist. After drying, it can be transferred to dried inerting agent 26. As described above, inerting agent 26 serves to remove oxygen. For example, according to arrow 38, pyranose 2-oxidase (P2Ox) can be applied with a catalase (Pox CAT), for example by drop casting. The enzymes are embedded in a polyvinyl alcohol matrix (5 mg/ml PVA, 25 mM phosphate, 20 μM EDTA, pH 7.3).

As indicated by arrow 40, an additional reagent 42, in this case glucose, can be applied to improve the removal of oxygen as described below. This embodiment is advantageous for nitrate sensors as biosensor 10, for example. Glucose can be applied in a concentration of 9 mg/ml in ultrapure water as reagent 42. Glucose should be applied separately to prevent the oxidase from immediately reacting the substrate. After these method steps step IV can be finished.

Basically, it can be intended that the reagent 42 is considered part of the inerting agent 26, so that in principle, when talking about an inerting agent 26, it can be a substance or can have a substrate or reagent 42 in addition to an enzyme, for example.

For forming level VII, a sensor base 44 can be provided first. A number of electrodes 14, 16, 18 can be applied to this, which are designed or can be used as working electrode 14, counter electrode 16 and reference electrode 18. The application can be done by printing or other coating methods. Furthermore, the electrodes 14, 16, 18 can be formed from a metal or an electrically conductive carbon. This can produce stage V.

Subsequently, the detection agent 22 is applied to the working electrode 14 according to arrow 45 to generate stage VII. Depending on the application possibility, e.g. of a coating, the detection agent 22 can be applied as intermediate stage VI while it is still wet and then, after drying, be converted into the dried inerting agent 22 according to stage VII. In detail, it may be intended that a nitrate reductase (NaR) embedded in a viologen polyvinyl alcohol polymer is applied by drop casting as detection agent 22 to a working electrode 14 designed as a screen-printing electrode.

Afterwards, the stages IV and VII can be connected to each other in such a way that the side of the sensor base 44 provided with the electrodes 14, 16, 18 is directed towards the lateral boundaries 32, 34 and the interspace 36, respectively. In detail, the sensor base 44 is fixed, e.g. by gluing, to the lateral boundaries 32, 34 in such a way that the electrodes 14, 16, 18 extend into the detection space 12 formed by the interspace 36 and the detection agent 22 is present in the detection space 12. Furthermore, the contact area 24 is provided, where the electrodes 14, 16, 18 can be contacted externally, for example by an evaluation unit. This can be realized by making the sensor cover 30 less long than the sensor base 44.

It is further provided that the length of the capillary detection space 12 between that of the working electrode 14 and the inlet opening 28 and the inerting agent 26 are selected and adapted to each other in such a way that oxygen diffusing from the inlet opening 28 in the direction of the working electrode 14 in an analyte solvent present in the detection space 12 can be completely removed from the analyte solvent by the inerting agent 26 before reaching the working electrode 14.

Exemplary but in no way limiting dimensions of such a biosensor 10 are shown in FIG. 2 for clarification, where FIG. 2a) shows the top view of step V, where FIG. 2b) shows a transparent top view of a part of step VIII, namely without electrodes 14, 16, 18, without inerting agent 26, without reagent 42 and detection agent 22, i.e. only on the base body of the biosensor 10, and where FIG. 2C shows a partly transparent view of step VIII for clarification.

In detail it is shown in FIG. 2a) that the length of the sensor base 44, shown as the length 46, is 20 mm, and that the width of the sensor base 44, shown as the width 48, is 5 mm. Furthermore, the width 50 is 1 mm, as an example for the reference electrode 18. The working electrode 14 can also have a width of 3.5 mm.

In FIG. 2b) it is shown that the capillary detection space 12 has a diameter or width as width 52 of 1 mm or 2 mm. Such configurations can be suitable for creating a detection space 12 with a volume in a range of ≤10 μl, for example ≤5 μl.

Deciding for the effective removal of dissolved oxygen in the vicinity of the working electrode 14 are the dimensions of the detection space 12. Based on the activity of the inerting agent 26, e.g. the enzyme activity, and the diffusion constant for oxygen in the analyte solvent, such as aqueous solutions, a model can be created by which the time can be estimated and the distance of the working electrode 14 to the inlet opening 28 can be determined. To achieve effective oxygen removal, the working electrode 14 can be located about 5 mm from the inlet opening 28. This results in a minimum length of the detection space 12 of 15 mm. The detection space 12 can have a diameter of 1-2 mm and a height of 100 μm. A length of 15 mm results in a total volume of 1.5 or 3.0 μl.

FIG. 3 shows a cross-section through the detection space 12, with the inerting agent 26 and glucose as additional reagent 42. An oxygen removal of the inerting agent 26 is shown when using the biosensor 10 as nitrate sensor.

The analyte (nitrate) is drawn up together with the analyte solvent by capillary action into the detection space 12, as shown in FIG. 1a). However, the sample is in exchange with the ambient air, so that atmospheric oxygen is constantly entering the sample, which must be removed. The dissolved oxygen is removed by a coupled enzyme reaction, as described below.

Reagent 42 and inerting agent 26 are soluble in the analyte solvent and are dissolved by filling the detection space 12. Thereby the reagent 42 and the inerting agent 26 are combined with each other and the enzyme system (P2OxCAT), which in this configuration serves as inerting agent 26, can start to remove the dissolved oxygen by reacting the glucose as reagent 42 with the oxygen as shown in FIG. 3b). Oxygen that goes into solution from the ambient air is completely removed by the inerting agent 26 in cooperation with its reagent 42. Detecting agent 22 is immobilized on the working electrode 14. Due to the anaerobic conditions an interference-free measurement of the analyte can be performed as shown in FIG. 3c). FIG. 3d) also shows the oxygen content in the analyte solvent in μM on the Y-axis relative to the distance to the inlet opening 28, which is shown in mm on the X-axis. It is shown that from a distance 54 of about 1.5 mm from the inlet opening 28 all oxygen is removed from the analyte solvent; thus, anaerobic conditions are present for a measurement.

In the following, examples are shown, which shall show the effective effect of a biosensor 10 designed as described above.

Before the first examples were carried out, simulations were used to determine the minimum concentrations for the enzyme system as inerting agent 26 for oxygen removal in order to achieve an effective oxygen removal after ≤10 seconds for given dimensions of electrodes 12, 14, 16 as described above. The simulation was performed on the basis of enzyme kinetic data of the enzyme pyranose oxidase (Rungsrisuriyachai, ABB, 2008; https://doi.org/10.1016/j.abb.2008.12.018). Furthermore, the following values were assumed for the diffusion of oxygen in water as the analyte solvent (2.4 10-5 cm²*s⁻¹, Fourmond, JACS, 2015; DOI 10.1021/jacs.5b01194). In order to ensure full saturation of inerting agent 26 with its substrate or reagent 42, the concentration of glucose as concentration of the reagent 42 was set at 10 mmol/l.

The concentration of Pyranose Oxidase, which is necessary for a complete oxygen removal after ≤10 seconds, was determined to 10 μmol/l. The simulation is shown in FIG. 4, where the x-axes show the distance of the respective position in the detection space 12 to the inlet opening 28 and the y-axis indicates a dimensionless concentration. Furthermore, the diagram a) shows the starting point of the measurement, the diagram b) a time after 10 seconds and the diagram c) a time after 300 seconds. Furthermore, the dashed lines describe the position of electrodes, the left line showing the position of the reference electrode 18 and the right line showing the working electrode 14. The counter-electrode can be located directly at the inlet opening, as shown in FIGS. 1 to 3. Line A further describes the concentration of oxygen and line B describes the concentration of glucose as reagent 42, the diagrams in FIG. 4 showing that the solution remains oxygen-free for at least 300 seconds after oxygen removal after 10 seconds.

Assuming a constant diffusion of oxygen and a constant activity of the enzyme as inerting agent 26, the substrate or reagent 42 (glucose) in the concentration of 10 mmol/l is sufficient to keep the solution theoretically free of oxygen for ≤1200 minutes. This is shown in FIG. 5. This shows a diagram, where the x-axis shows the distance to the inlet opening 28 and the y-axis shows a dimensionless concentration, and where further the diagram shows a time after 1440 minutes. Furthermore, the dashed lines describe the position of electrodes. The left line shows the position of the reference electrode 18 and the right line the working electrode 14. The counter-electrode can be located directly at the inlet opening 28, as shown in FIGS. 1 to 3. Line A describes the concentration of oxygen and line B describes the concentration of glucose as reagent 42.

The increase of the oxygen concentration on the right side of the diagrams of FIGS. 4 and 5 can be explained by the fact that the detection space 12 in this configuration was open on both sides, the axis thus strictly speaking shows the distance to an inlet opening 28, but another one is at 15 mm, the detection space thus has a length of 15 mm, as described above.

In a first experiment, the liquid to be tested could be absorbed by capillary action and detection space 12 could thus be completely filled with liquid, i.e. analyte solvent with analyte dissolved in it. For the example experiments shown in the following figures, a biosensor 10 was used for nitrate detection. Nitrate reductase was used as sensor enzyme. For oxygen removal an enzyme system comprising pyranose oxidase and catalase was used (as described in U.S. Pat. No. 9,187,779 B2). A gold electrode was used for the working electrode 14, although other materials such as glassy carbon are also conceivable for the working electrode 14 or the other electrodes 16, 18. A silver/silver chloride system was used as reference electrode 18.

In the first experiment, the electrodes 14, 16, 18 produced by screen printing were tested without inerting agent 26 for oxygen removal. This is shown in FIG. 6, with this experiment represented by the curves A of the diagram shown in FIG. 6. In the diagram in FIG. 6, the Y-axis shows the current in μA and the X-axis shows the voltage in volts of the electrode against Ag/AgCl paste as reference electrode 18. This experiment clearly shows the influence of oxygen on the measurement signal in the range 0.8 V to 0.3 V. The curves B and C, on the other hand, show the removal of oxygen by glucose oxidase (curve B) and by pyranose oxidase (curve C) as inerting agent 26. For the removal of oxygen by pyranose oxidase, a closed test strip or biosensor 10 was used. The other two experiments were performed with non-closed biosensors 10, i.e. without sensor covers. As reaction buffer 25 mM phosphate, 20 μM EDTA, pH 7.3 was used. The enzymes for oxygen removal were used with 1 mg/ml glucose oxidase/pyranose oxidase and catalase each. As substrate or reagent 42 9 mg/ml glucose was used. It has been shown that the influence of oxygen can be essentially eliminated by the inerting agent 26, if necessary, again with its reagent 42.

In order to show the effective effect of a biosensor 10, for example designed as a test strip, a concentration series with different concentrations of potassium nitrate (0.5 to 16 mM) in the solution was measured on an open system, i.e. without sensor cover 30, as shown in FIGS. 7 and 8. In the diagrams a) and b) the curve A shows a concentration of 0 mM, the curve B shows a concentration of 0.05 mM, the curve C shows a concentration of 0.1 mM, the curve D shows a concentration of 0.25 mM, the curve E shows a concentration of 0.5 mM, the curve F shows a concentration of 0.75 mM, the curve G shows a concentration of 1 mM, the curve H shows a concentration of 2 mM, the curve I shows a concentration of 4 mM, the curve J shows a concentration of 8 mM and the curve K shows a concentration of 16 mM

The enzyme system for oxygen removal as inerting agent 26 was also added directly to the solution. Here, the current is shown in μA on the Y-axis and the voltage in volts of the electrode against Ag/AgCl paste as reference electrode 18 is shown on the X-axis.

FIG. 8 also shows the current in μA at a voltage of −0.8 V on the Y-axis against the known nitrate concentrations in mM on the X-axis. With this plot the linear range of the biosensor can be determined. A linear range of 0-500 μM could be determined. Afterwards the measurement signal quickly reaches saturation from a concentration of 4,000 μM. This enables a strong detection of the analyte.

For FIGS. 7 and 8, 25 mM phosphate, 20 μM EDTA, pH 7.3 was used as reaction buffer. The enzymes for oxygen removal were used with 1 mg/ml each of pyranose oxidase and catalase. As substrate or reagent 42 9 mg/ml glucose was used. Nitrate reductase was used at a concentration of 1 mg/ml. Each cycle was performed at a feed rate of 2 mV/s. One cycle was completed in 3.3 minutes. Different concentrations of potassium nitrate ranging from 0.05 to 16 mM were used for the concentration series. Diagram b) shows the repeated measurement of the concentration series with a new biosensor 10 to demonstrate the reproducibility.

In FIG. 8 the current at a voltage of −0.8V is plotted against the known concentrations. From this plot the linear range can be determined.

To demonstrate the functionality of a biosensor 10 as a nitrate test strip, a closed strip with the sensor enzyme nitrate reductase as detection agent 22 was prepared and this test strip was used to detect potassium nitrate in a solution. This is shown in FIG. 9, where the X-axis again indicates the voltage in volts and the Y-axis indicates the current in μA. Curve A shows a concentration of potassium nitrate of 0 mM and curve B shows a concentration of potassium nitrate of 10 mM.

The reaction buffer used in this experiment was 25 mM phosphate, 20 μM EDTA, pH 7.3. The enzymes for oxygen removal were used with 1 mg/ml each of pyranose oxidase and catalase. As substrate 9 mg/ml glucose was used. Nitrate reductase was used at a concentration of 1 mg/ml. It is shown that an effective detection of nitrate is possible.

From the above, it is clear that the Biosensor 10 described here can be used to produce sensors designed as test strips for bioanalytical problem (e.g. blood sugar, nitrate) in which dissolved oxygen in the sample is completely removed. This has the advantage that the removed oxygen has no influence on the sensor enzymes and thus on the measurement. This makes it possible to produce biosensors that have a higher accuracy because the oxygen effect is completely eliminated. Furthermore, this method of oxygen removal and the specific design of the biosensor 10 can also be used to produce novel biosensors 10 that use oxygen-sensitive sensor enzymes.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

### REFERENCE SIGNS

10 biosensor

12 detection space

14 working electrode

16 counter electrode

18 reference electrode

20 measuring region

22 detection agent

24 contact area

26 inerting agent

28 inlet opening

30 sensor cover

32 lateral boundary

34 lateral boundary

36 interspace

38 arrow

40 arrow

42 reagent

44 sensor base

45 arrow

46 length

48 width

50 width

52 width

54 distance

1. An electrochemical biosensor for the detection of at least one analyte dissolved in an analyte solvent, comprising a capillary detection space and a plurality of electrodes, wherein the plurality of electrodes comprises at least one working electrode having a measuring region positioned in the capillary detection space, which is provided with an immobile detection agent for interacting with the analyte, and wherein the plurality of electrodes further comprises a counter electrode extending into the capillary detection space, and wherein the plurality of electrodes is electrically contactable outside the capillary detection space, characterized in that the capillary detection space has a volume in a range of ≤10 μl, wherein an oxygen-binding or oxygen-reactive inerting agent is further provided in the capillary detection space, which is positioned at least partially between the working electrode and an inlet opening of the capillary detection space, and wherein the length of the capillary detection space between the working electrode and the inlet opening and the inerting agent are selected and adapted to one another in such a way, in that oxygen diffusing in the analyte solvent arranged in the detection space from the inlet opening in the direction of the working electrode can be completely removed from the analyte solvent by the inerting agent before reaching the working electrode.

2. The biosensor according to claim 1, wherein the volume of the capillary detection space is in a range from ≤10 μl.

3. The biosensor according to claim 1, wherein the distance between the working electrode and the inlet opening is in a range from ≥2 mm to ≤15 mm.

4. The biosensor according to claim 1, wherein the inerting agent is an enzyme-based inerting agent.

5. The biosensor according to claim 1, wherein the detection agent is an enzyme-based detection agent.

6. A system for the detection of at least one analyte dissolved in a solvent, comprising a biosensor according to claim 1 and further comprising an analyte solvent arranged in the capillary detection space of the biosensor, wherein at least one analyte to be detected is provided in the analyte solvent.

7. The system according to claim 6, wherein the inerting agent is at least partially soluble or dissolved in the analyte solvent.

8. The system according to claim 6, wherein the system further comprises an evaluation unit which electrically contacts the plurality of electrodes and by which at least one of the type and the amount of the analyte can be determined from information supplied by the electrodes.

9. A method for the detection of at least one analyte dissolved in a solvent, comprising the method steps:
a) providing a biosensor according to claim 1,
b) filling the capillary detection space with analyte dissolved in the analyte solvent, wherein
c) when filling the capillary detection space, the analyte dissolved in the analyte solvent is passed from the inlet opening to the detection agent;
d) contacting the electrodes externally; and
e) determining at least one of the amounts and the type of the analyte by information provided by the electrodes.

10. The method according to claim 9, wherein oxygen diffusing in the analyte solvent from the inlet opening in the direction of the detection agent can be completely removed from the analyte solvent by the inerting agent.

11. The method according to claim 9, wherein during or after method step b) the inerting agent at least partially dissolves in the analyte solvent.

12. A method for making a biosensor for the detection of at least one analyte dissolved in an analyte solvent, a biosensor according to claim 1, wherein the method comprises the method steps
i) providing a base body with a capillary detection space, wherein the detection space (12) has a volume in a range of ≤10 μl;
ii) arranging a plurality of electrodes in such a way that they are externally electrically contactable and extend into the detection space;
iii) arranging a detection agent on an electrode serving as a working electrode; and
iv) arranging an inerting agent in the detection space, between an inlet opening of the detection space and the electrode serving as working electrode, wherein
v) the length of the capillary detection space between the electrode serving as working electrode and the inlet opening and the inerting agent are selected and adapted to each other in such a way, in that oxygen diffusing in the analyte solvent arranged in the detection space from the inlet opening in the direction of the electrode serving as working electrode can be completely removed from the analyte solvent by the inerting agent before reaching the electrode serving as working electrode.

13. The method according to claim 12, wherein the method comprises the following method steps:
vi) providing a sensor cover;
vii) applying two lateral boundaries to the sensor cover in such a way that the lateral boundaries define an interspace between the lateral boundaries forming the detection space, and that the lateral boundaries form an inlet opening at least on one side;
viii) applying an inerting agent to the interspace;
ix) providing a sensor base;
x) applying at least two electrodes to the sensor base;
xi) applying a detection agent to an electrode to be used as a working electrode; and
xii) fixing the sensor base on the lateral boundaries such a way that the electrodes extend into the detection space formed by the interspace, and that the detection agent is present in the detection space.

14. Use of at least one of a biosensor, a system or a method according to claim 1 for the detection of at least one analyte dissolved in a solvent.

15. The use according to claim 14, wherein at least one of a biosensor, a system or a method is used for glucose determination or nitrate determination.
